(19) United States
(12) Patent Application Publication
(10) Pub. No.: US 2025/0036080 A1
(43) Pub. Date: Jan. 30, 2025

(54) ASSEMBLY FOR ATTACHING A BALANCE SPRING FOR A HOROLOGICAL MOVEMENT, BALANCE SPRING AND METHOD FOR ADJUSTING THE BEAT AND RATE OF A SPRUNG BALANCE ASSEMBLY

(71) Applicant: ETA SA MANUFACTURE HORLOGÈRE SUISSE, Grenchen (CH)

(72) Inventor: Julien CHRISTAN, Bienne (CH)

(73) Assignee: ETA SA MANUFACTURE HORLOGÈRE SUISSE, Grenchen (CH)

(21) Appl. No.: 18/763,554

(22) Filed: Jul. 3, 2024

(30) Foreign Application Priority Data
Jul. 24, 2023 (EP) 23187212.8

(51) Int. Cl. G04B 17/06; G04B 17/20; G04B 17/34; G04B 18/00

(52) U.S. Cl. CPC G04B 17/063; G04B 17/20; G04B 17/34; G04B 18/006

(57) ABSTRACT

An assembly for the removable attachment of a balance spring of a horological movement including a balance bridge, the assembly including the balance spring, a means of retaining the balance spring, and a removable locking part. The balance spring includes a coil winding which extends between a first free end of an inner first coil and a second free end of an outer last coil, the second free end including an attachment means in which the retaining means is engaged to ensure the removable attachment of the balance spring by its outer last coil. The attachment means is dimensioned so that, in a rest position, the balance spring is not in contact with the retaining means engaged in this attachment means, the locking part for the removable attachment of the second free end being engaged on the retaining means to lock the attachment means.

### CROSS REFERENCE TO RELATED APPLICATION

This application claims priority to European Patent Application No. 23187212.8 filed Jul. 24, 2023, the entire contents of which are incorporated herein by reference.

### TECHNICAL FIELD OF THE INVENTION

The present invention relates to an assembly for attaching a balance spring for a horological movement. The present invention further relates to an adjustment method for such an attaching assembly.

### TECHNOLOGICAL BACKGROUND

In the field of watchmaking, a balance spring, combined with a balance, forms a regulating member commonly referred to as a sprung balance for mechanical timepieces. At first glance, the balance spring takes the form of a very thin spring that is wound about itself in coils when no stress is exerted thereon. When mounted, a first end of the balance spring, referred to as the inner first coil, is attached to a collet fitted on a balance staff, and a second end of the balance spring, referred to as the outer last coil, is attached to a balance spring stud, which part is typically attached by means of a stud holder in a balance bridge.

More specifically, the time base for mechanical timepieces, also referred to as the oscillating system, comprises a sprung balance assembly and an escapement. The balance consists of a balance staff pivoted between a first and a second bearing and connected to a balance felloe by means of radial arms. The balance spring is attached by its inner first coil to the balance staff, for example by means of a collet, and is attached by its outer last coil to a fixed attachment point such as a balance spring stud carried by a stud holder.

In a very common embodiment, the escapement comprises a double roller system consisting of a large roller which carries an impulse pin and a small roller in which a hollow is made. The escapement further comprises a pallet-lever, a pallet staff of which is pivoted between a first and a second bearing. The pallet-lever consists of a lever that connects a fork to an entry arm and an exit arm. The fork consists of an entry horn and an exit horn and carries a dart. The travel of the fork is limited by an entry banking pin and an exit banking pin, which can be made in one piece with a pallet bridge. The entry arm and the exit arm carry an entry pallet and an exit pallet respectively. Finally, the pallet-lever cooperates with an escape wheel set comprising an escape wheel and an escapement pinion, this assembly formed by the escape wheel and pinion being pivoted between a first and a second bearing.

A balance spring is a spring that is spiral-shaped when at rest. Wound in a plane parallel to the plane of the horological movement, the balance spring serves a single function: to cause the balance to oscillate about its position of equilibrium, also referred to as the point of rest, at as constant a frequency as possible. When the balance leaves its position of equilibrium by pivoting in a given direction, the balance spring contracts. This creates a restoring torque in the balance spring that causes the balance to return to its position of equilibrium. During this beat, the balance spring relaxes. However, as the balance has acquired a certain speed, and thus kinetic energy, it overshoots its position of equilibrium in the opposite direction until the restoring torque exerted by the balance spring on the balance stops it again and forces it to rotate in the opposite direction.

The balance spring thus expands and contracts alternately: it is said to breathe. However, many factors can play a part in preventing a balance spring from developing isochronously during the expansion and contraction phases. In particular, the balance spring must withstand oxidation and magnetism, which cause the coils to stick together and work to disrupt the precision of the watch, or even stop it entirely. Atmospheric pressure, on the other hand, has little influence. For a long time, temperature has been the main problem, because heat expands the metal, while cold shrinks it. The balance spring must thus be resilient so that it can deform and yet always return to its original shape.

The material used to produce balance springs is usually steel. Being ductile, the steel used must resist corrosion. Developments over the past two decades have also proposed producing balance springs from silicon. Silicon balance springs allow a greater precision of the rate than their steel predecessors, in particular because they are insensitive to magnetism. However, they have a higher cost price and, because they are fragile, they are more difficult to assemble.

A balance spring must be isochronous. Regardless of how far the balance rotates, it must always take the same amount of time to oscillate. If the balance spring contracts by just a few degrees, it accumulates little energy and returns slowly to its position of equilibrium. If the balance spring has moved far from its position of equilibrium, it very quickly moves in the opposite direction. The important thing is that these two journeys take the same amount of time to complete. The underlying idea is that the energy available to the balance spring is not constant and that it must still function, whether the watch is fully wound or in the final hours of its power reserve.

Because of their small dimensions, balance springs are difficult to assemble. However, the way in which the two ends of a balance spring are attached also has a major influence on the precision of the rate of the horological movement. In most mechanical horological movements, the two ends of the balance spring are inserted into a drilled part and rendered immobile by means of a pin which is forcibly assembled manually using pliers. This can cause the balance spring to rotate slightly, which is detrimental to the precision of the rate of the movement.

Another technique consists of attaching the ends of the balance springs using an adhesive. However, this technique also has its limitations. It has been observed that, due to its viscosity, the adhesive exerts a tensile force on the balance spring by capillary action and can press the ends of the balance spring against the walls of the balance spring stud in which these ends are engaged. The resulting deformation of the balance spring induces mechanical stresses therein, which mechanical stresses are detrimental to keeping a consistent rate.

To remedy these problems, the Applicant has already proposed a method for attaching a balance spring consisting of adhesively bonding the outer last coil of a balance spring in a stud by means of a drop of fluid adhesive which can be polymerised, for example, by means of ultraviolet radiation. Thus, even if, when the drop of adhesive is deposited, for example by means of a syringe-type adhesive dispenser, the free end of the last coil of the balance spring moves slightly under the effect of the weight of the drop of adhesive, which induces undesired mechanical stresses in the balance spring, the adhesive is sufficiently fluid before hardening to allow the free end of the last coil of the balance spring to return spontaneously to its rest position. The mechanical stresses induced in the balance spring when the drop of liquid adhesive is deposited thus disappear on their own, and the consistency of the rate of the balance spring is not affected by the adhesive bonding operation carried out thereon.

The above solution thus allows a balance spring to be attached, by the free end of its outer last coil, within a stud while eliminating all, or at least most, of the mechanical stresses usually induced in such a balance spring during the assembly thereof. This greatly improves the consistency of the rate of the balance spring. During use, however, the Applicant has nonetheless realised that the hardened adhesive pad formed when the drop of liquid adhesive used to attach the free end of the outer last coil of the balance spring is polymerised sometimes tends to detach from the stud, which, of course, causes the horological movement in which this balance spring is installed to immediately fail. Such a situation is due in particular to problems with the surface condition of the stud, which prevent the adhesive pad from adhering perfectly to the stud, and due to the creep and ageing of the adhesive pad over time. Moreover, when the ambient temperature rises, most adhesives soften, which consequently modifies the active length, and thus the stiffness, of the balance spring, and thus has a negative impact on the rate of the horological movement.

Finally, it should be noted that, particularly in the case of top-of-the-range horological movements, the use of adhesives or synthetic products that are hardly compatible with the high level of finishing and expertise required for such horological movements is avoided as far as possible.

European patent application EP1515200A1 is known for a balance spring for a sprung balance assembly of a mechanical horological movement, a free end of an outer last coil of which includes an opening capable of resilient deformation in order to receive and clamp an attaching element of the balance spring stud type. Preferably, the attaching element has a cylindrical shape with a circular cross-section including flat areas with which the free end of the outer last coil of the balance spring is in contact to prevent this free end from rotating about the attaching element during operation of the movement. The attaching element allows the free end of the outer last coil of the balance spring to be attached without the need for auxiliary attaching means such as pins or adhesive. Furthermore, by adjusting the position of the free end of the outer last coil of the balance spring relative to the attaching element, it is possible to adjust the height of this free end on the attaching element. This is made possible by the fact that the free end of the outer last coil of the balance spring is frictionally engaged on the attaching element. This is problematic, however, as there is a risk that in the event of an impact, for example, the free end of the outer last coil will change position in relation to its attaching element, or even become detached from this attaching element, which at best will alter the precision of the rate of the sprung balance assembly, or at worst will cause the timepiece to fail. It should also be noted that, given that the attachment of the outer last coil of the balance spring is ensured by the frictional forces arising from the resilient contact between the opening provided in the free end of the outer last coil of the balance spring and the attaching element, this does not guarantee the genuinely durable nature of the balance spring insofar as, with time and wear, these frictional forces will tend to relax, such that the frictional forces between the edges of the opening in the free end of the outer last coil of the balance spring and the attaching element quickly become insufficient to ensure that the balance spring is immobilised on this attaching element.

### SUMMARY OF THE INVENTION

The purpose of the present invention is to alleviate the above and other problems by providing a mechanical assembly allowing a balance spring for a horological movement to be securely attached without resilient deformation of the outer last coil and without the use of adhesive, whereby the balance spring can, if necessary, be disassembled and reassembled without risk of damage.

To this end, the present invention relates to an assembly for the detachable attachment of a balance spring of a horological movement comprising a balance bridge, this assembly comprising the balance spring on the one hand, and a means of retaining the balance spring as well as a detachable locking part on the other hand, the balance spring comprising a coil winding which extends between a first free end of an inner first coil and a second free end of an outer last coil, the second free end of the outer last coil of the balance spring having an attaching means in which the retaining means is engaged for releasably attaching the balance spring by its outer last coil, the attaching means being dimensioned so that, in its natural rest position, the balance spring is not in contact with the retaining means engaged in this attaching means, the locking part for ensuring the removable attachment of the second free end of the outer last coil of the balance spring being mounted on the retaining means, in order to lock the attaching means.

In a particular embodiment of the invention, the attaching means is an opening formed in the second free end of the outer last coil of the balance spring.

In a particular embodiment of the invention, the second free end of the outer last coil of the balance spring, in which the opening is formed, is made in one piece with the balance spring assembly.

In another particular embodiment of the invention, the opening is formed by a bent portion of the second free end of the outer last coil of the balance spring.

In yet another particular embodiment of the invention, the second free end of the outer last coil of the balance spring is provided with a plate in which the opening is formed.

In yet another particular embodiment of the invention, the plate is secured to the second free end of the outer last coil of the balance spring.

In yet another particular embodiment of the invention, the plate is attached by welding to the second free end of the outer last coil of the balance spring.

In yet another embodiment of the invention, the opening is oblong in shape.

In yet another embodiment of the invention, the oblong opening has a major axis in the continuation of the outer last coil.

In yet another particular embodiment of the invention, the retaining means comprises a post arranged to engage in the opening formed in the second free end of the outer last coil of the balance spring.

In yet another particular embodiment of the invention, the post is made in one piece with the balance bridge of the horological movement.

In yet another particular embodiment of the invention, the retaining means comprises a support part formed by a stud surmounted by the post.

In yet another particular embodiment of the invention, the support part is arranged in a recess formed in the balance bridge.

In yet another particular embodiment of the invention, the support part is arranged in the recess by friction fitting.

In yet another particular embodiment of the invention, the support part is screwed into the recess.

In yet another particular embodiment of the invention, to prevent the support part from being unscrewed accidentally, a retaining part is arranged between the balance bridge and the support part.

In yet another particular embodiment of the invention, the retaining part is a spring washer.

In yet another embodiment of the invention, the locking part is a washer which is removably attached to the post.

In yet another embodiment of the invention, the washer is driven onto the post.

In yet another particular embodiment of the invention, a flexible element intended to modify the stiffness of the balance spring is arranged between the second free end of the outer last coil of the balance spring and a lever surrounding the coil winding and terminating in a plate in which the opening is formed.

The invention further relates to a method for adjusting the rate of a sprung balance assembly attached by means of the attaching assembly according to the invention, in which the attachment means included in the second free end of the outer last coil of the balance spring is engaged on the post of the support part, the support part being, if necessary, pivoted in one direction or the other until the post is no longer in contact with the attachment means of the balance spring, whereupon the beat of the sprung balance assembly is adjusted by pivoting this sprung balance assembly about the balance staff until the impulse pin of the balance roller is aligned with an escapement line passing through the balance staff and a pallet staff, and then, once the beat of the sprung balance assembly has been adjusted, it is again ensured that the post of the support part is not in contact with the attachment means of the balance spring and, if this is the case, the support part is rotated again so as to move the post away from the attachment means of the balance spring, then the removable locking part is attached to the post to lock the second free end of the outer last coil of the balance spring.

The invention further relates to a method for adjusting the rate of a sprung balance assembly in which the balance spring is attached by means of the attaching assembly according to the invention, wherein, after attaching the removable locking part to the post in order to lock the second free end of the outer last coil of the balance spring, the support part is pivoted clockwise or counter-clockwise, thereby driving the second free end of the outer last coil of the balance spring.

Thanks to these features, the present invention provides an assembly allowing a balance spring of a horological movement to be attached without the aid of adhesive, in a removable, repositionable manner, guaranteeing immobilisation of the free end of the outer last coil of the balance spring without inducing mechanical stress in this balance spring, in particular in a plane in which the winding of the coils of this balance spring extends, so that the regularity of rate of the horological movement is not affected.

### BRIEF DESCRIPTION OF THE FIGURES

Other features and advantages of the present invention will become clearer from the following detailed description of one embodiment, this example being given by way of a non-limiting illustration only, with reference to the accompanying drawing in which:

FIG. 1 is a general perspective view of an assembly for the removable attachment of a balance spring of a horological movement in its simplified embodiment;

FIG. 2 is a general perspective view of an assembly for the removable attachment of a balance spring of a horological movement in its improved embodiment;

FIG. 3 is a top view of a silicon balance spring comprising first and second flexible arms for use in the attaching assembly of FIG. 2;

FIG. 4 is a perspective view of a balance spring, the outer last coil of which is provided with a plate in one piece and in which the opening is formed for receiving the post;

FIG. 5 is a perspective view of a balance spring fitted with a plate attached to the free end of the outer last coil of this balance spring and in which the opening is formed for receiving the post;

FIG. 6 is a perspective view of a balance spring, the outer last coil of which is bent to form the opening that receives the post;

FIG. 7 is a diagrammatic view illustrating the case in which the post is made in one piece with the balance bridge of the horological movement;

FIG. 8 is a diagrammatic view illustrating the case in which the retaining means comprises a support part formed by a stud surmounted by a post and arranged by friction fitting in a recess formed in the balance bridge;

FIG. 9 illustrates the case in which the retaining means comprises a support part formed by a stud surmounted by a post and arranged in a recess formed in the balance bridge by screwing with the interposition of a washer between the balance bridge and the support part to prevent any untimely unscrewing;

FIG. 10 is a perspective view of a balance spring, the outer last coil of which is bent to form a hook to receive the post;

FIGS. 11 and 12 illustrate, in the assembled state and in the disassembled state respectively, the case in which the retaining means is arranged in the manner of a support part disposed in a recess formed in the balance bridge, the outer last coil of the balance spring being capped by a locking part provided with a post which is received in an opening formed in the support part.

### DETAILED DESCRIPTION OF THE INVENTION

The present invention was drawn from the general inventive idea consisting of providing a mechanical assembly allowing the second free end of the outer last coil of a balance spring for a sprung balance assembly of a horological movement to be attached without the use of adhesive. By making it possible to dispense with the use of adhesive, the present invention avoids the problems associated with such materials, particularly in terms of ageing and creep, as well as in terms of image; more specifically, particularly in the field of top-of-the-range timepieces, it is clearly understood that it will be sought as far as possible to avoid having to resort to assembling mechanical parts using adhesive. According to another of its advantages, the mechanical assembly according to the invention allows the second free end of the outer last coil of the balance spring to be attached in a removable manner, so that the positioning of the balance spring can be readjusted if necessary when the timepiece is returned to the workshop. Another advantage of the mechanical assembly according to the invention is that it allows the second free end of the outer last coil of a balance spring for a horological movement to be attached without inducing mechanical stress in this second end, in particular in the plane in which the coil winding that forms the balance spring extends, which is very favourable in terms of the precision of rate of the sprung balance assembly.

Referred to in its entirety by the general reference numeral 1, the attaching assembly according to the invention is intended for the removable attachment of a balance spring 2 of a horological movement comprising a balance bridge 4.

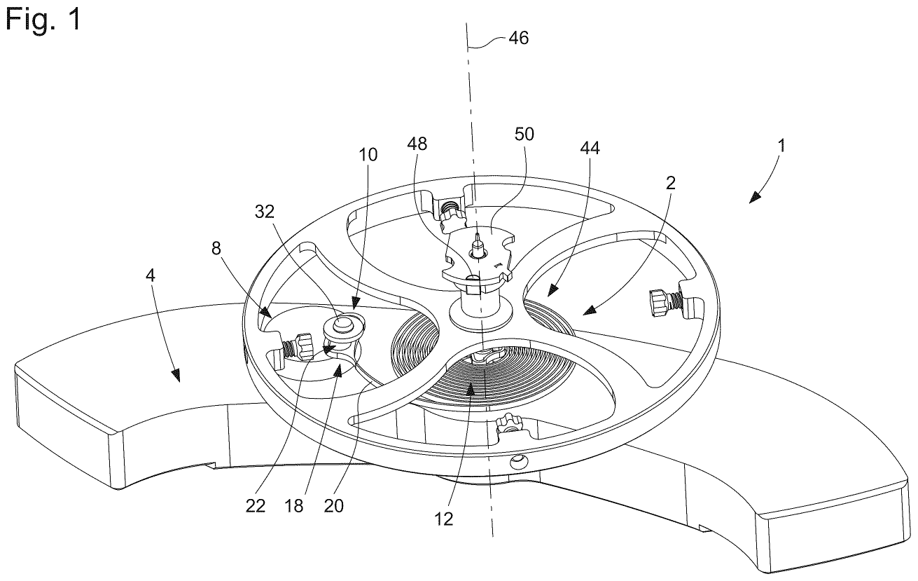

More specifically, and as shown in FIG. 1, this attaching assembly 1 comprises, in addition to the balance spring 2, a retaining means 8 and a removable locking part 10.

As can be seen from FIG. 1, the balance spring 2 comprises a coil winding 12 which extends between a first free end 14 of an inner first coil 16 and a second free end 18 of an outer last coil 20. According to the invention, the second free end 18 of the outer last coil 20 of the balance spring 2 includes an attachment means which, in a preferred and non-limiting embodiment of the invention, is in the form of an opening 22 in which the retaining means 8 is engaged to ensure the removable attachment of the balance spring 2 by its outer last coil 20. The opening 22 is dimensioned so that, in the natural rest position of the balance spring 2, the edges 24 of this opening 22 are not in contact with the mechanical attachment means 8 engaged in this opening 22. Thus, the attachment of the balance spring 2 by means of the attaching assembly 1 according to the invention does not induce any stress in this balance spring 2 in a plane X-Y in which the balance spring 2 extends, and thus has no influence on the precision of the rate. The removable locking part 10, which is intended to ensure the removable attachment of the second free end 18 of the outer last coil 20 of the balance spring 2, is engaged, preferably by driving, on the retaining means 8, following the balance spring 2.

According to a special embodiment of the invention, the opening 22 provided in the second free end 18 of the outer last coil 20 of the balance spring 2 is preferably but not exclusively oblong in shape, with a major axis 26 extending in the continuation of the outer last coil 20 (see FIG. 3).

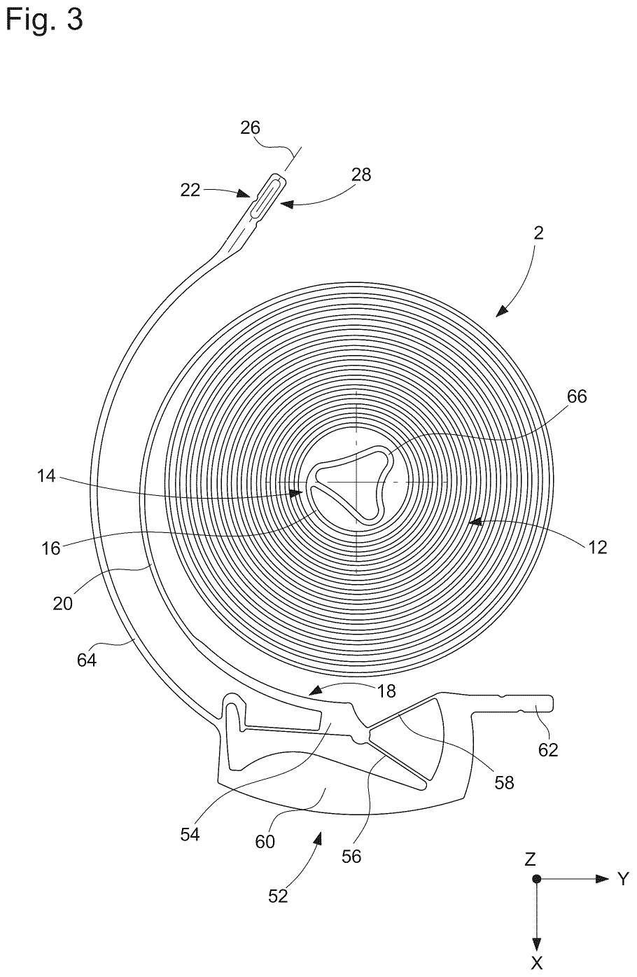

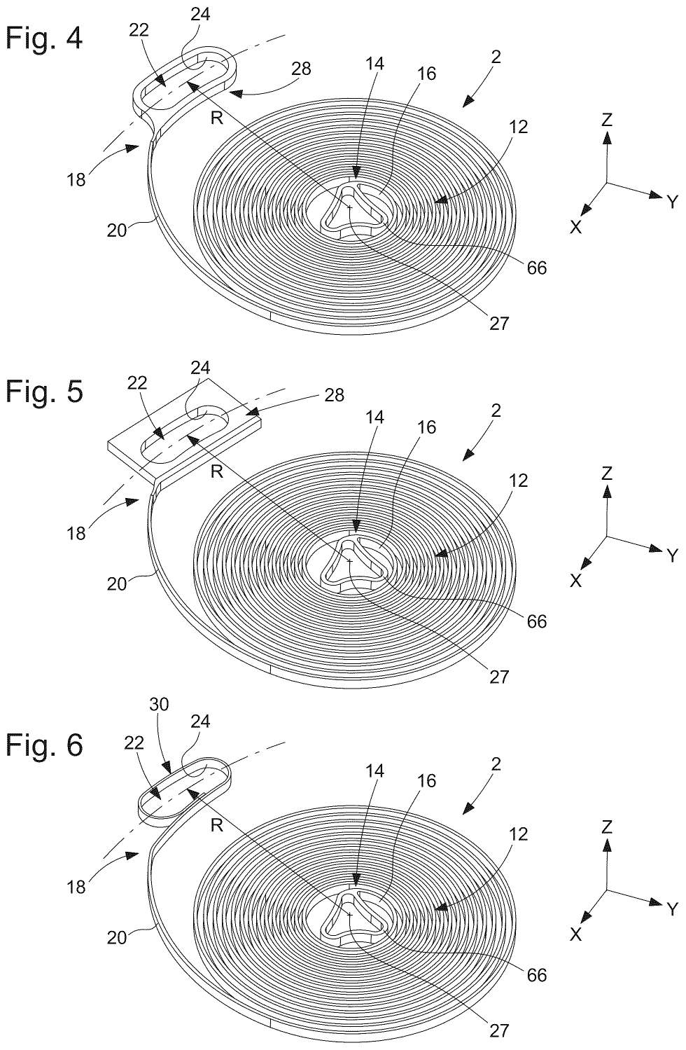

In the embodiments illustrated in FIG. 4 to 6, the opening 22 is oblong in shape with a radius of curvature R centred on the centre 27 of the coil winding 12.

The opening 22 can be materialised in different ways.

In one embodiment of the invention, the second free end 18 of the outer last coil 20 of the balance spring 2, in which the opening 22 is formed, is made in one piece with the balance spring 2 assembly. The outer last coil 20 of the balance spring 2 can thus be provided with a plate 28 made in one piece and in which the opening 22 is formed (FIG. 4). Conversely, the plate 28 can be attached to the second free end 18 of the outer last coil 20 of the balance spring 2, for example by a joining process such as welding (FIG. 5). It is also possible to form the opening 22 by means of a bent portion 30 of the second free end 18 of the outer last coil 20 of the balance spring 2 (FIG. 6).

The retaining means 8 comprises a post 32 arranged to engage in the opening 22 formed in the second free end 18 of the outer last coil 20 of the balance spring 2.

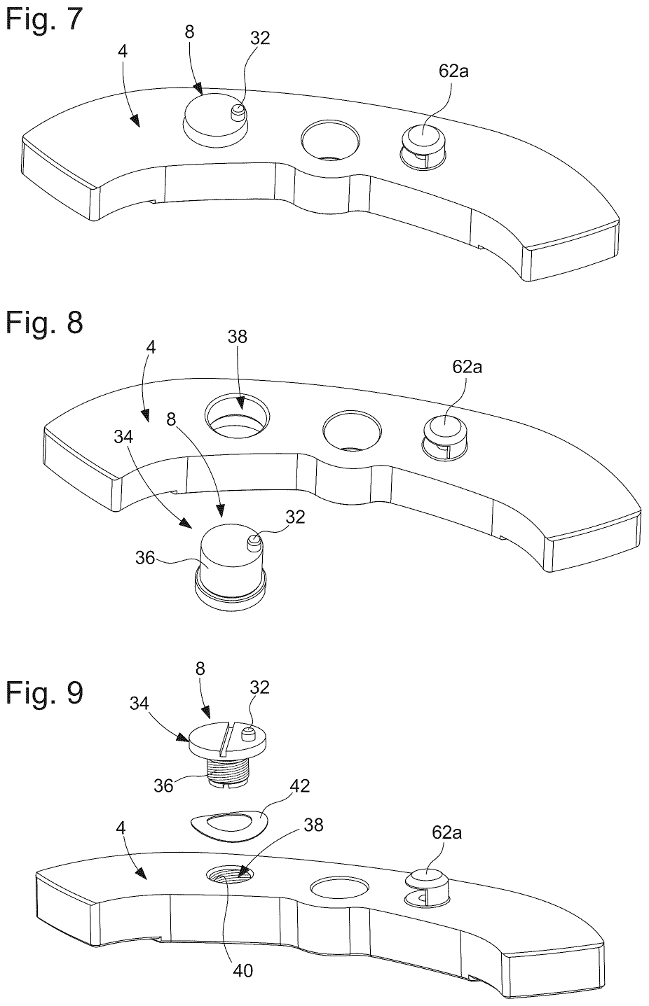

In a first embodiment, the post 32 is made in one piece with the balance bridge 4 of the horological movement (FIG. 7).

According to another embodiment of the invention, the retaining means 8 comprises a support part 34 formed by a stud 36 surmounted by the post 32. This support part 34 is arranged in a recess 38 formed in the balance bridge 4. The support part 34 is positioned in the recess 38 either by friction fitting (FIG. 8) or by screwing (FIG. 9). If the support part 34 is screwed into the recess 38, the support part 34 is externally threaded and the recess 38 is provided with a complementary thread on an inner side wall 40. To prevent the support part 34 from being unscrewed accidentally, a retaining part 42 such as a spring washer can be arranged between the balance bridge 4 and the support part 34 (FIG. 9).

The removable locking part 10 is a washer attached to the post 32 in a removable manner, typically by driving in.

In its simplified embodiment, the attaching assembly 1 according to the invention allows the beat of a sprung balance assembly 44 to be adjusted. Moreover, in its preferred embodiment, the attaching assembly 1 according to the invention allows not only the beat of the sprung balance assembly 44 to be adjusted, but also the rate of such a sprung balance assembly 44.

As already described above, the attaching assembly 1 according to the invention is mounted firstly by engaging the opening 22 provided in the second free end 18 of the outer last coil 20 of the balance spring 2 on the post 32 of the support part 34. Normally, the entire mechanical assembly formed by the balance spring 2, the sprung balance assembly 44 equipped with such a balance spring 2 and the retaining means 8 is dimensioned so that, when the post 32 of the support part 34 is engaged in the opening 22 in the balance spring 2, the edges 24 of the opening 22 in the balance spring 2 are not in contact with the post 32 engaged in this opening 22. However, in the rare event that this is not the case, the present invention advantageously allows the support part 34 to be pivoted slightly in one direction or the other until the post 32 is no longer in contact with the edges 24 of the opening 22 in the balance spring 2. Thereafter, the beat of the sprung balance assembly 44 is adjusted by rotating this sprung balance assembly 44 about a balance staff 46 until an impulse pin 48 of a balance roller 50 is aligned with an escapement line passing through the balance staff 46 and a pallet staff (not shown in the drawing). Once the beat of the sprung balance assembly 44 has been adjusted, it is once again ensured that the post 32 of the support part 34 is not in contact with the edges 24 of the opening 22 in the balance spring 2; as before, in the extremely rare event that this should not be the case, the present invention makes it possible to rotate the support part 34 again so as to move the post 32 away from the edges 24 of the opening 22 in the balance spring 2, then to drive the washer onto the post 32 to lock the second free end 18 of the outer last coil 20 of the balance spring 2. Conversely, i.e. if no contact is observed between the edges 24 of the opening 22 in the balance spring 2 and the post 32 of the support part 34, the balance spring 2 can be locked directly by attaching the washer to the post 32.

It is of course understood that the support part 34 cannot be pivoted if it is made in one piece with the balance bridge 4.

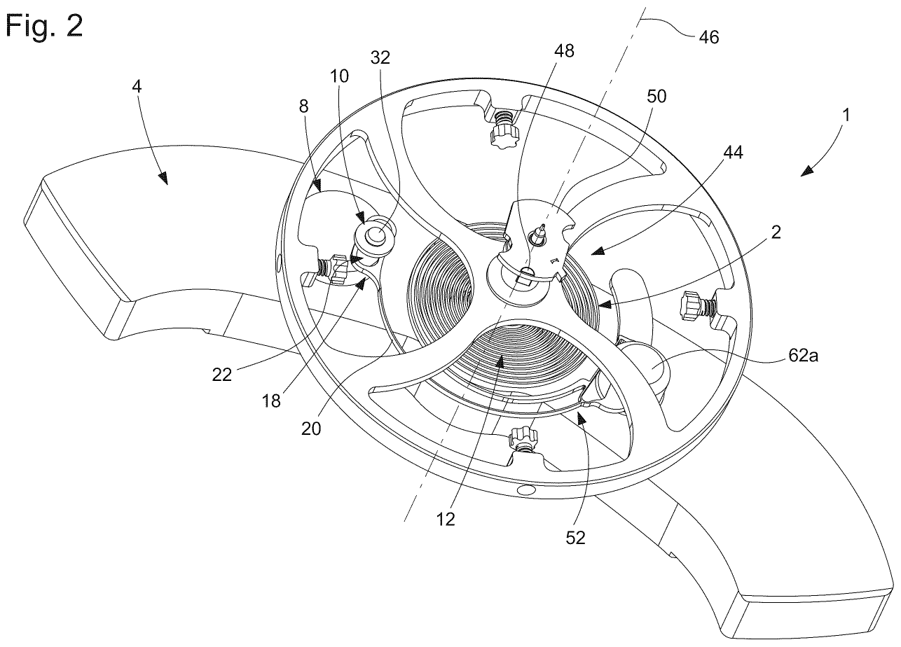

In the preferred embodiment of the invention illustrated from a perspective view in FIG. 2, it is possible not only to adjust the beat of the sprung balance assembly 44, but also to adjust the rate of this sprung balance assembly 44. The operation of adjusting the rate of the sprung balance assembly 44 takes place after the second free end 18 of the outer last coil 20 of the balance spring 2 has been locked by attaching the washer to the post 32. At this point, the support part 34 is pivoted clockwise or counter-clockwise, thereby driving the second free end 18 of the outer last coil 20 of the balance spring 2.

More specifically, FIG. 3 shows that the balance spring 2 comprises a flexible element 52 consisting of a pivot 54 comprising first and second non-crossing flexible blades 56, 58 and a rigid part 60. The first and second flexible blades 56, 58 are joined, on the one hand laterally to an elongate fixed support part 62, and on the other hand to the pivot 54 by moving towards each other. Thus, the flexible blades 56, 58 move towards each other from the fixed support part 62 to the pivot 54. The fixed support part 62 is attached to an attaching part 62a integral with the bridge 4. The second free end 18 of the outer last coil 20 of the balance spring 2 is joined to the pivot 54. In the figure, the variable torque is applied to an additional blade 63 which connects the outer last coil 20 to the rigid part 60, so that the stiffness of this additional blade is modified and, as a result, the stiffness of the balance spring 2 and thus the rate of the sprung balance assembly 44. To this end, the balance spring 2 is extended beyond its flexible element 52 by a lever 64 which bypasses the coil winding 12 and terminates in a plate 28 in which the opening 22 in accordance with the invention is provided. The torque is transmitted to the balance spring 2 via the lever 64 and the flexible element 52. For a full description of the balance spring 2 used in this improved embodiment of the present invention, reference is made to European patent application EP21202213.1 filed by the Applicant.

It goes without saying that the present invention is not limited to the embodiment just described and that various simple modifications and alternative embodiments can be envisaged by a person skilled in the art without departing from the scope of the invention as defined by the accompanying claims.

The post 32 can be made in one piece with the balance bridge 4. In the case where the support part 34 is a separate part mounted by drive fitting in a recess 38 machined in the balance bridge 4, it can be pivoted in both clockwise and counter-clockwise directions. When the support part 34 is pivoted, the post 32 is also pivoted, so that this post 32 does not come into contact with the edges 24 of the contour of the opening 22 made in the free end 18 of the outer last coil 20 of the balance spring 2. The balance spring 2 can thus be placed spontaneously in its natural rest position, free of any mechanical stress, which is the most favourable solution for the precision of rate of the sprung balance assembly 44.

Typically speaking, balance springs 2, particularly when they are made of silicon, are manufactured to very tight tolerances, so that the position of the geometric centre of the opening 22 made in the free end 18 of the outer last coil 20 of the balance spring 2 is known very precisely in advance, which makes it possible to position the post 32 precisely on the balance bridge 4, or alternatively the support part 34 corresponding to the assembly formed by the stud 36 and the post 32 in the recess 38 provided for this purpose in the balance bridge 4.

If the balance spring 2 is made of silicon, the free end 18 of the outer last coil 20 of the balance spring 2, in which the opening 22 is formed, is made in one piece with the balance spring 2 assembly. If the balance spring 2 is made of a metal alloy, the opening 22 intended to receive the post 32 of the support part 34 can be formed by simply bending the free end 18 of the outer last coil 20 of the balance spring 2. It can also be possible to attach, typically by welding, to the free end 18 of the outer last coil 20 of the balance spring 2, a plate 28 in which an opening 22 is formed to receive the post 32 of the support part 34.

In the extremely rare case where, after installation of the balance spring 2 and engagement of the post 32 in the opening 22 provided in the free end 18 of the outer last coil 20 of the balance spring 2, it is observed that the edges 24 of this opening 22 come into mechanical contact with the post 32 at any point, the present invention advantageously allows the support part 34 to be pivoted until no mechanical contact can be observed. Thus, whatever the circumstances, the present invention makes it possible to guarantee immobilisation of the free end 18 of the outer last coil 20 of the balance spring 2 without any stress being induced in the X-Y plane in which the balance spring 2 extends, which is very favourable for the precision of rate of the sprung balance assembly 44.

In the simplified alternative embodiment of the invention, there is a single point of attachment of the free end 18 of the outer last coil 20 of the balance spring 2, namely the post 32 of the support part 34 engaged in the opening 22 formed in the free end 18 of the outer last coil 20 of the balance spring 2, which acts as a balance spring stud, and only the beat of the sprung balance assembly 44 can thus be adjusted.

In the improved alternative embodiment of the invention, there are two attachment points and the balance spring 2 is preferably made of silicon; in this case, there are two attachment points and both the beat and the rate of the sprung balance assembly 44 can be adjusted. Moreover, it is understood that, thanks to the invention, the rate of the sprung balance assembly 44 can be finely adjusted in different ways: by modifying the inertia of the balance, for example by adding or removing material, or by screwing or unscrewing weights. It is also possible to adjust the rate of the sprung balance assembly 44 by modifying the stiffness of the balance spring 2 in accordance with the invention. Some sprung balance assemblies can even be adjusted in both ways simultaneously.

The stud 36 of the support part 34 can be threaded to allow fine adjustment of the height along an axis Z perpendicular to the support surface provided by the support part 34. To prevent the threaded support part 34 from unscrewing unintentionally, a retaining part 42, for example of the spring washer type, can be arranged between the threaded support part 34 and the surface of the balance bridge 4 in order to lock the threaded stud 36. Thanks to the invention, by modifying the stiffness of the balance spring 2 attached to the balance staff 46 by means of a collet 66, it is possible to adjust the rate of the sprung balance assembly 44, which is much simpler than adjusting the rate of a sprung balance assembly by modifying the inertia of the balance, for example by adding or removing material, or by moving weights or screws etc.

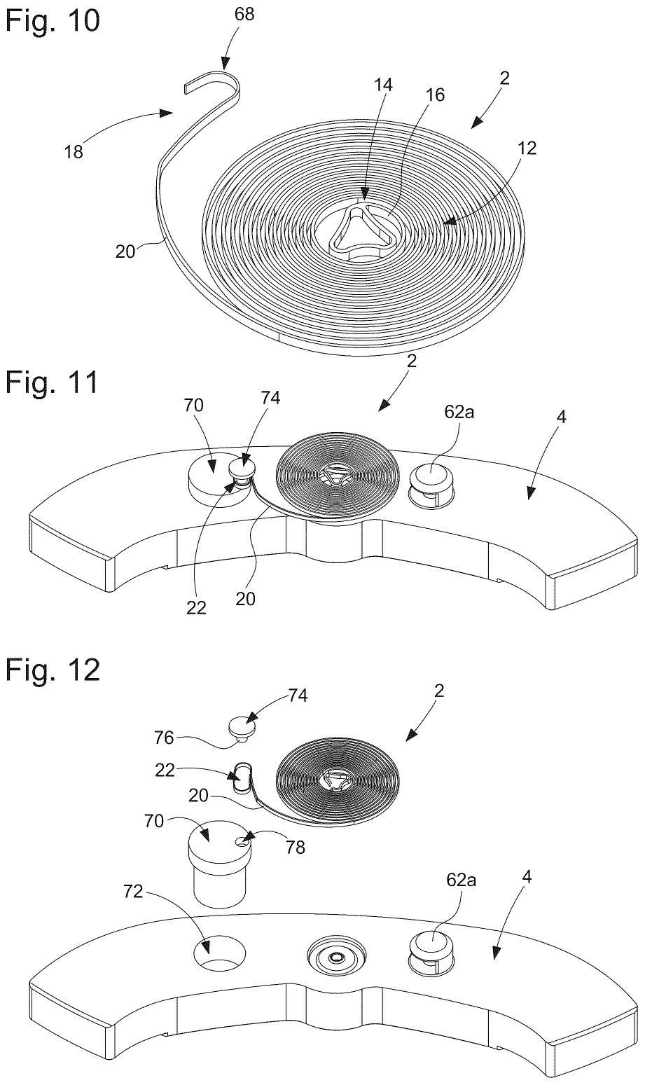

According to a special embodiment of the invention illustrated in FIG. 10, the attachment means can have an open geometry, for example shaped like a hook 68, in which the retaining means 8 is engaged to ensure the removable attachment of the balance spring 2 by its outer last coil 20. This retaining means 8, of the type of a post 32, is arranged in the internal space delimited by the hook 68 and held in place by the retaining part 42. Normally, when the balance spring 2 is fitted, there should be no mechanical contact between the hook 68 and the post 32. However, if this is not the case, the support part 34 can be rotated until no mechanical contact can be observed.

According to a special embodiment of the invention, the retaining means 8 comprises a support part 70 arranged in a recess 72 formed in the balance bridge 4. The support part 70 is arranged in the recess 72 either by friction fitting or by screwing. The free end 18 of the outer last coil 20 of the balance spring 2 rests on this support part 70 and is capped by a locking part 74 provided, on the underside, with a post 76 which is received in an opening 78 made in the support part 70.

### NOMENCLATURE

1. Attaching assembly
2. Balance spring
4. Balance cock
8. Retaining means
10. Removable locking part
12. Coil winding
14. First free end
16. Inner first coil
18. Second free end
20. Outer last coil
22. Opening
24. Edges
26. Major axis
27. Centre
28. Plate
30. Bent portion
32. Post
34. Support part
36. Stud
38. Recess
40. Inner side wall
42. Retaining part
44. Sprung balance assembly
46. Balance staff
48. Impulse pin
50. Balance roller
52. Flexible element
54. Pivot
56. First flexible blade
58. Second flexible blade
60. Rigid part
62. Fixed support
62a. Attaching part
63. Additional blade
64. Lever
66. Collet
68. Hook
70. Support part
72 Recess
74. Locking part
76. Post
78. Opening

1. An assembly (1) for the removable attachment of a balance spring (2) of a horological movement comprising a balance bridge (4), said assembly comprising the balance spring (2) on the one hand, a retaining means (8) for the balance spring (2), and a removable locking part (10) on the other hand, the balance spring (2) comprising a coil winding (12) which extends between a first free end (14) of an inner first coil (16) and a second free end (18) of an outer last coil (20), the second free end (18) of the outer last coil (20) of the balance spring (2) including an attachment means in which the retaining means (8) is engaged in order to ensure the removable attachment of the balance spring (2) by its outer last coil (20), the attachment means being dimensioned so that, in its natural rest position, the attachment means is not in contact with the retaining means (8) engaged in this attachment means, the locking part (10) for removably attaching the second free end (18) of the outer last coil (20) of the balance spring (2) being mounted on the retaining means (8) to lock the attachment means.

2. The assembly (1) for attaching a balance spring (2) according to claim 1, wherein the attachment means is an opening (22) provided in the second free end (18) of the outer last coil (20) of the balance spring (2).

3. The assembly (1) for attaching a balance spring (2) according to claim 2, wherein the opening (22) is oblong in shape and has a major axis (26) in the continuation of the outer last coil (20).

4. The assembly (1) for attaching a balance spring (2) according to claim 1, wherein the second free end (18) of the outer last coil (20) of the balance spring (2), in which the opening (22) is formed, is made in one piece with the balance spring (2) assembly.

5. The assembly (1) for attaching a balance spring (2) according to claim 1, wherein the opening (22) is formed by a bent portion (30) of the second free end (18) of the outer last coil (20) of the balance spring (2).

6. The assembly (1) for attaching a balance spring (2) according to claim 1, wherein the second free end (18) of the outer last coil (20) of the balance spring (2) is provided with a plate (28) in which the opening (22) is formed.

7. The assembly (1) for attaching a balance spring (2) according to claim 6, wherein the plate (28) is secured to the second free end (18) of the outer last coil (20) of the balance spring (2).

8. The assembly (1) for attaching a balance spring (2) according to claim 7, wherein the plate (28) is attached by welding to the second free end (18) of the outer last coil (20) of the balance spring (2).

9. The assembly (1) for attaching a balance spring (2) according to claim 1, wherein the retaining means (8) comprises a post (32; 76) arranged to engage in the opening (22) provided in the second free end (18) of the outer last coil (20) of the balance spring (2).

10. The assembly (1) for attaching a balance spring (2) according to claim 9, wherein the post (32) is made in one piece with the balance bridge (4) of the horological movement.

11. The assembly (1) for attaching a balance spring (2) according to claim 9, wherein the retaining means (8) comprises a support part (34) formed by a stud (36) surmounted by the post (32).

12. The assembly (1) for attaching a balance spring (2) according to claim 11, wherein the support part (34) is disposed in a recess (38) formed in the balance bridge (4).

13. The assembly (1) for attaching a balance spring (2) according to claim 12, wherein the support part (34) is arranged in the recess (38) by friction fitting.

14. The assembly (1) for attaching a balance spring (2) according to claim 12, wherein the support part (34) is screwed into the recess (38).

15. The assembly (1) for attaching a balance spring (2) according to claim 14, wherein, in order to prevent untimely unscrewing of the support part (34), a retaining part (42) is disposed between the balance bridge (4) and the support part (34).

16. The assembly (1) for attaching a balance spring (2) according to claim 15, wherein the retaining part (42) is a spring washer.

17. The assembly (1) for attaching a balance spring (2) according to claim 9, wherein the locking part (10) is a washer attached to the post (32) in a removable manner.

18. The assembly for attaching a balance spring according to claim 17, wherein the washer is driven onto the post (32).

19. The assembly according to claim 9, wherein the retaining means (8) comprises a support part (70) disposed in a recess (72) formed in the balance bridge (4) and capped by a locking part (74) provided with a post (76) which is received in an opening (78) formed in the support part (70).

20. The assembly for attaching a balance spring according to claim 1, wherein a flexible element (52) arranged to modify the stiffness of the balance spring (2) is disposed between the second free end of the outer last coil of the balance spring and a lever (64) which surrounds the coil winding (12) and in a free end of which the opening (22) is provided.

21. A method for adjusting the beat of a sprung balance assembly comprising a balance spring (2) attached by means of the attaching assembly according to claim 1, wherein the attachment means included in the second free end (18) of the outer last coil (20) of the balance spring (2) is engaged on the post (32) of the support part (34), the support part (34) being, if necessary, pivoted in one direction or the other until the post (32) is no longer in contact with the attachment means of the balance spring (2), whereupon the beat of the sprung balance assembly (44) is adjusted by pivoting this sprung balance assembly (44) about a balance staff (46) until the impulse pin (48) of the balance roller (50) is aligned with an escapement line passing through the balance staff and a pallet staff, and then, once the beat of the sprung balance assembly (44) has been adjusted, it is ensured that the post (32) of the support part (34) is not again in contact with the attachment means of the balance spring (2) and, if this is the case, the support part (34) is rotated again so as to move the post (32) away from the attachment means of the balance spring (2), then the removable locking part (10) is driven onto the post (32) to lock the second free end (18) of the outer last coil (20) of the balance spring (2).

22. A method for adjusting the rate of a sprung balance assembly (44) whose balance spring is attached by means of the attaching assembly according to claim 1, wherein, after the removable locking part (10) has been driven onto the post (32) in order to lock the second free end (18) of the outer last coil (20) of the balance spring (2), the support part (34) is pivoted clockwise or counter-clockwise, thereby driving the second free end (18) of the outer last coil (20) of the balance spring (2).
